(19) United States
(12) Patent Application Publication
(10) Pub. No.: US 2016/0062950 A1
(43) Pub. Date: Mar. 3, 2016

(54) SYSTEMS AND METHODS FOR ANOMALY DETECTION AND GUIDED ANALYSIS USING STRUCTURAL TIME-SERIES MODELS

(71) Applicant: Google Inc., Mountain View, CA (US)

(72) Inventors: Kay H. Brodersen, Zurich (CH); Havard Garnes, Zurich (CH); Dimitris Meretakis, Zurich (CH); Olaf Bachmann, Zurich (CH); Steven Lee Scott, Mountain View, CA (US)

(21) Appl. No.: 14/585,675

(22) Filed: Dec. 30, 2014

(30) Foreign Application Priority Data
Sep. 3, 2014 (GR) 20140100449

(51) Int. Cl. G06F 17/18

(52) U.S. Cl. CPC G06F 17/18

(57) ABSTRACT

Systems and methods for anomaly detection and guided analysis using structural time-series model. A server may receive a request from a client to analyze a time-series data comprising a plurality of data points. A database of global calendars may be accessed. A structural time-series model may be built from the time-series data and the database of global calendars, the structural time-series model comprising a hidden structure and a plurality of probability distributions, each probability distribution corresponding to a data point. For each data point of the time-series data, a range of expected values is determined from a respective probability distribution, the range of expected values capturing a predefined percentage of the respective probability distribution. An anomaly is detected at a first data point of the time-series data responsive to comparing the first data point with a respective range of expected values. The anomaly is transmitted to the client for display with the time-series data.

### CROSS-REFERENCE TO RELATED APPLICATIONS

This application claims the benefit under 35 USC §119(b) of Greek Application number 20140100449, filed Sep. 3, 2014, which is incorporated by reference herein in its entirety.

### BACKGROUND

Time-series data are a sequence of data points measured at successive points in time. Systems and methods that detect anomalies in time-series data allows for the analysis of vast amounts of data. The systems and methods described herein ensure anomaly detection and guided analysis that are statistically meaningful, avoid overfitting, and provide a generative model for forecasting.

### SUMMARY

One implementation of the present disclosure is a computer-implemented method for detecting anomalies in time-series data. The method includes receiving a request to analyze time-series data. An events database that includes global calendars is accessed. Using the time-series data and the global calendars, a structural time-series model is built. The model allows a determination of a range of expected values for each data point of the time-series data. An anomaly is detected at any data point in the time-series data that lies outside the respective range of expected values. The detected anomaly is transmitted to the client for display with the time-series data.

Another implementation of the present disclosure is a system for anomaly detection and forecasting time-series data. The system includes a network interface of a server receiving a request to analyze time-series data. A structural time-series module of the server accesses a database of calendars and builds a structural time-series model from the time-series data and the database of global calendars. An anomaly detector of the server determines a range of expected values for each data point in the time-series data. An anomaly is detected at a first data point responsive to comparing a first data point of the time-series data with a respective range of expected values. A report generator transmits the anomaly to the client for display with the time-series data.

### BRIEF DESCRIPTION OF THE DRAWINGS

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

The details of one or more implementations are set forth in the accompanying drawings and the description below. Other features, aspects, and advantages of the disclosure will become apparent from the description, the drawings, and the claims, in which:

FIG. 1 is a block diagram of a computer system including a network, an analysis server client device, an analysis server, an events database, a data collection system and a sensor;

FIG. 2A is a block diagram of a data collection system including a network, a resource server client device, a resource server, and a server monitor;

FIG. 2B is another block diagram of a data collection system including a network, third-party content providers, a content item management system, third-party content server, resource server client devices, resource servers, and a content item selection system;

FIG. 3 depicts one implementation of a process for detecting an anomaly in a time-series data;

FIG. 4 depicts one implementation of a process for parallelizing the time-series analysis;

FIG. 5 is a block diagram illustrating one implementation of the analysis server of FIG. 1 in greater detail;

FIG. 6 is an illustration of the Bayesian structural time-series model used to determine anomalies and generate forecasting from time-series data.

FIG. 7A is an illustration of a time-series data;

FIG. 7B is an illustration of a time-series data with an expected range of values with detected anomalies and forecasting; and

FIG. 8 is an illustration of a graphical interface for specifying a threshold.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatus, and systems for providing information on a computer network. The various concepts introduced above and discussed in greater detail below may be implemented in any of numerous ways, as the described concepts are not limited to any particular manner of implementation. Specific implementations and applications are provided primarily for illustrative purposes.

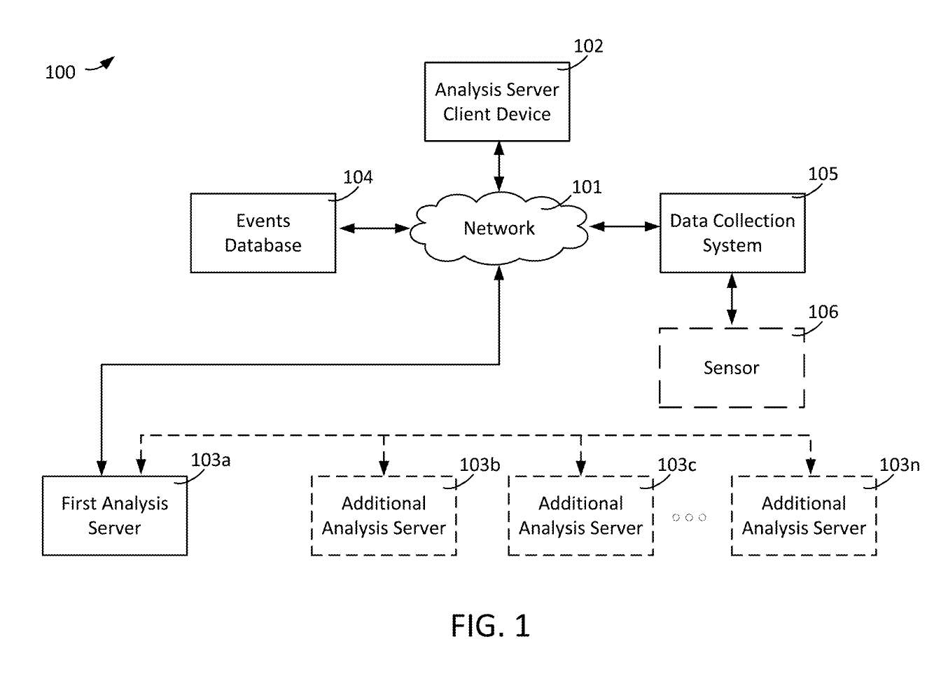

FIG. 1 is a block diagram of a computer system 100 including a network 101, an analysis server client device 102, one or more analysis servers 103a-n (referred to as 103), an events database 104, a data collection system 105 and an optional sensor 106. The system 100 may be used to detect anomalies and generate forecasts.

The system 100 may use at least one computer network 101. The network 101 may include a local area network (LAN), wide area network (WAN), a telephone network, such as the Public Switched Telephone Network (PSTN), an cellular network, a wireless link, an intranet, the Internet, or combinations thereof. The network 101 may support communication using one or more stacks of protocols, such as the TCP/IP stack.

The analysis server client device 102 may include any number and/or type of user-operable electronic device. For instance, an analysis server client device 102 may include a desktop computer, laptop, smart phone, wearable device, smart watch, tablet, personal digital assistant, set-top box for a television set, smart television, gaming console device, mobile communication device, remote workstation, client terminal, entertainment console, or any other device configured to communicate with other devices via the network 101. The analysis server client device 102 may be any form of electronic device that includes a data processor and a memory. The memory may store machine instructions that, when executed by a processor, cause the processor to request an analysis of a time-series data to the first analysis server 103a over the network 101. The memory may store the time-series data. The memory may also store data to effect presentation of the analysis and the time-series data. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, ECMAScript®, Hyptertext Markup Language (HTML), Java®, JavaScript®, ECMAScript®, Mathematica®, Matlab®, Perl®, Python®, R, Statistical Analysis System® (SAS®), Statistical Package for the Social Sciences® (SPSS®), Stata®, Visual Basic®, and Extensible Markup Language (XML). The analysis server client device 102 may include an interface element (e.g., an electronic display, a touch screen, a speaker, a keyboard, a pointing device, a mouse, a microphone, a printer, a gamepad, etc.) for presenting the time series and the analysis to a user, receiving user input, or facilitating user interaction with the presentation (e.g., clicking on an identified anomaly, changing the scale of the time axis, etc.). In some implementations, the analysis server client device 102 may include a sensor 106 for collecting time-series data. In the present application, the terms “time series,” “a time-series dataset,” and “a time-series data” may be used interchangeably.

The analysis server client device 102 can execute a software application (e.g., a web browser, a mobile program, or other application) to request, receive, and display an analysis of a time-series data. In the request, the analysis server client device 102 may specify the time-series data, a time range, a parameter for calculating a range of expected values, a threshold for anomaly detection, and a request for generating a forecast. The software application can display the analysis with the time-series data. For instance, the software application may display an indication of an anomaly at a data point of the time-series data that may be visible at a smaller time axis scale. In some implementations, the software application may display a forecast with the time-series data.

In some implementations, the analysis server client device 102 may provide the analysis server 103 with the time-series data. In such implementations, the analysis server client device 102 may be the data collection system 105 or communicate with the data collection system 105. In some implementations where the analysis server client device 102 collects the time-series data, the analysis server client device 102 may include a sensor 106.

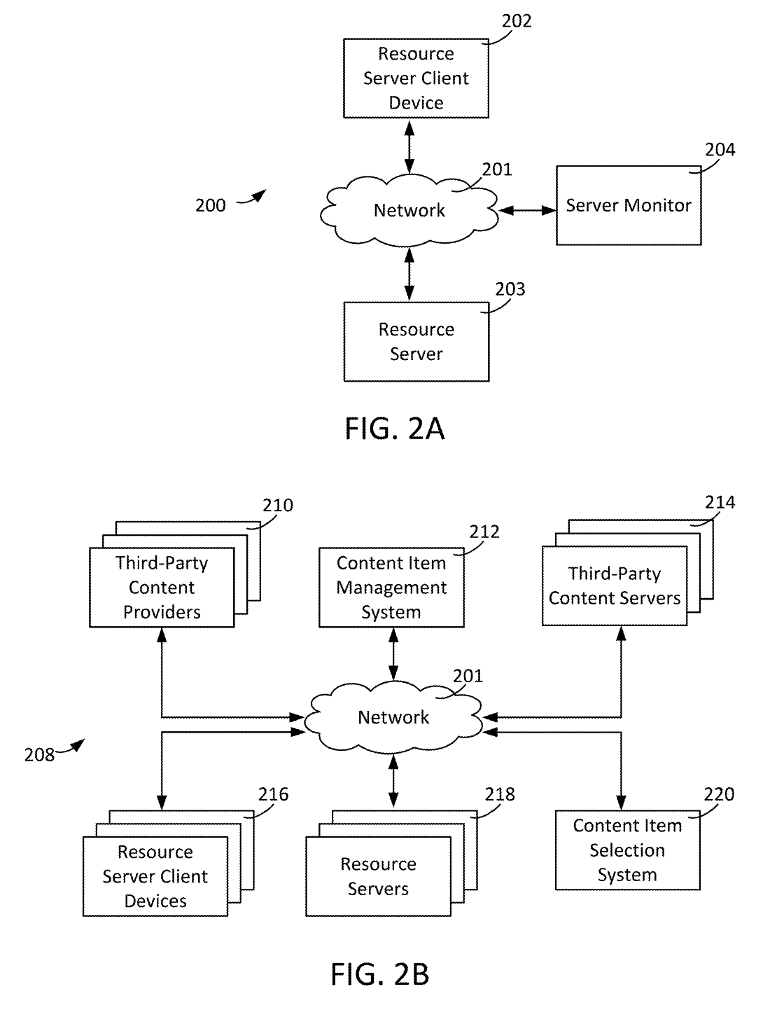

The data collection system 105 may include at least one computing device having memory and one or more processors. The computing device may communicate via the network 101. The memory may include volatile memory or non-volatile memory. Memory may include hard drives, optical drives, flash drives, or solid-state drives. Memory may store time-series data that may be updated as the data is collected. Memory may also store instructions that may be executed by the one or more processors. In other words, the one or more data processors and the memory device of the data collection system 104 may form a processing module. A processor may include a microprocessor, an application-specific integrated circuit (ASIC), a field-programmable gate array (FPGA), etc., or combinations thereof. The instructions may include code from any suitable computer programming language such as, but not limited to, ActionScript®, C, C++, C#, ECMAScript®, Hyptertext Markup Language (HTML), Java®, JavaScript®, ECMAScript®, Mathematica®, Matlab®, Perl®, Python®, R, SAS®, SPSS®, Stata®, Visual Basic®, and Extensible Markup Language (XML). The one or more processors may execute the instructions to collect the time-series data in memory. In some implementations, the data collection system 104 may include a sensor 106 that collects the time-series data. The data collection system 104 may also include one or more databases configured to store the time-series data. In some implementations, a data storage device may provide a memory element or the database. The data storage device may be connected with the data collection system 104 directly or via the network 101. The data collection system 105 may collect time-series data from one or more sources. Implementations of the data collection system 105 is described in greater detail in relation to FIG. 2A an FIG. 2B.

The sensor 106 may be a hardware device capable of measuring a physical quantity and converting it into an electrical signal that can be stored as a data point of the time-series data. A sensor may be a thermocouple, tactile sensor, heart-rate sensor, acoustic sensor, automotive or transportation sensor, chemical sensor, electric current sensor, environment sensor, flow or fluid sensor, navigation sensor, position sensor, distance sensor, speed sensor, acceleration sensor, optical sensor, or proximity sensor. The sensor 106 may be part of or be connected to a computing device of the data collection system 105 of the analysis server client device 102. The sensor 106 may continuously collect a physical quantity over a period of time at a set interval.

Time-series data may be collected from the network 101, other devices on the network, or from sensors 106. The time-series data may comprise a marketing data, online content auction data, server data, search data, or sensor data. The time-series data may be a data cube or a multi-dimension time-series data. The time-series data may comprise data points of a granularity, an interval, or a resolution, that describes time between adjacent data points.

The events database 104 can include a computing device configured to store a global calendar of events. In some implementations, the event database comprises a general-purpose computing device executing a database package, including: relational databases such as a MySQL; flat-file databases, such as Microsoft JET; distributed databases, such as HBase; and documented-oriented databases, such as MongoDB. The database server 130 may be a computer server (e.g., a file transfer protocol (FTP) server, a file sharing server, a web server, a database server, etc.), a group or a combination of servers (e.g., a data center, a cloud computing platform, a server farm, etc.). The events database 104 may be any type of a computing device that includes a memory element configured to store the global calendar. The events database 104 may include any type of non-volatile memory, media, or memory devices. For instance, events database 104 may include semiconductor memory devices (e.g., EPROM, EEPROM, flash memory devices, etc.) magnetic disks (e.g., internal hard disks, removable disks, etc.), magneto-optical disks, and/or optical disks. In some implementations, events database 104 is local to the analysis server 103. In other implementations, events database 104 is on remote data storage devices connected with the analysis server 103. In some implementations, the events database 104 is part of a data storage server or system capable of receiving and responding to queries from the analysis server 103.

In some implementations, the global calendar of events stored in the events database 104 may comprise one or more matrices that stores seasonal covariates that are used by the analysis server 103. In this application, matrix may be referred to as a calendar or events calendar. In some implementations, a matrix may be associated with a country, a region, or other geographic identifiers. For instance, a matrix may be associated with an identifier for the United States, and another matrix may be associated with an identifier for Germany. One dimension of the matrix may represent an event, and the other dimension of the matrix may represent a date. For each date, 1 is assigned to a element if a respective event falls on that date. Otherwise, 0 is assigned on that date for the respective event. Subsequently, a matrix may include elements of 0s and 1s and may be sparsely populated. The matrix may be stored in a vector form that only stores the location of the 1s.

In some implementations, the global calendar of events stored in the events database 104 may comprise a list of events. In such implementations, a matrix may be generated from the list of events based on the granularity of the time-series data. For instance, the granularity of the time-series data may be equal to the granularity of the row (or column) of the generated matrix. In other implementations, the granularity of the generated matrix may be between one percent to one hundred times the granularity of the time-series data. The list of events may be associated with a country, a region, or other geographic identifiers.

An event may be a recurring, periodic, or seasonal event. An event may be a floating or non-floating holiday. An event may include days of the week, days of the month, days of the year, time of day, and daylight savings start and end days. A matrix of events or a list of events may be edited to include custom recurring events, such as launch of satellites or sporting events such as Super Bowl for American football or World Cup for international soccer. For instance, a matrix may include the date of Dec. 25, 2014. In a matrix, the row (or column) corresponding to December will have an element of 1 for the event Christmas, as well as 1 for the event Thursday.

In some implementations, the events database 104 stores one matrix or one list that includes all events. In some implementations, the one list or matrix that stores all events is the only list or matrix in the database. In other implementations, the one list or matrix that stores all events is the default list or matrix such that, for any access to the events database 104 that does not include a geographic identifier that matches one of the other lists or matrices, the default list or matrix is used.

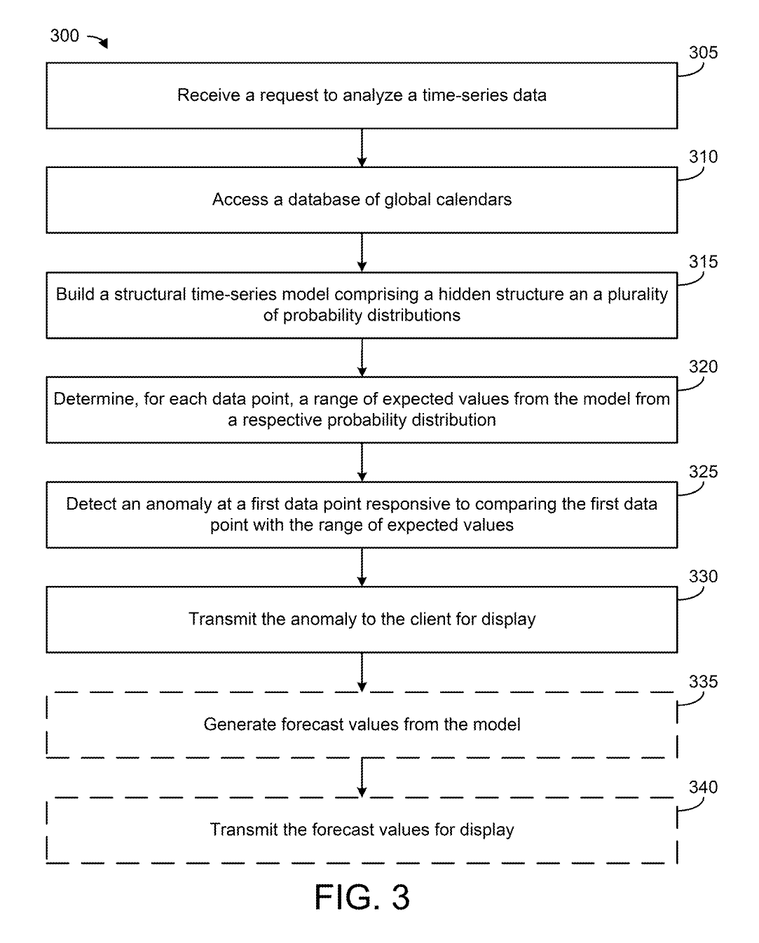

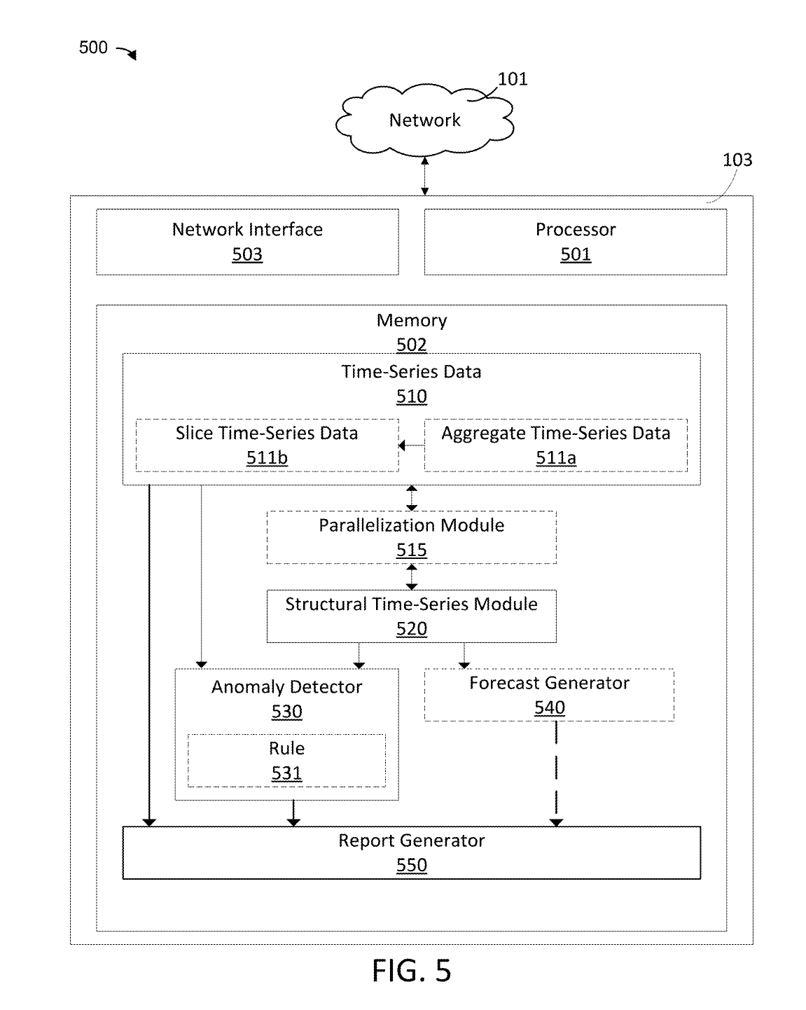

Each analysis server 103 may include at least one computing device having memory and one or more processors. The computing device may communicate via the network 101. The memory may include volatile memory or non-volatile memory. Memory may include hard drives, optical drives, flash drives, or solid-state drives. Memory may store time-series data that may be updated as the data is collected. Memory may also store instructions that may be executed by the one or more processors. In other words, the one or more data processors and the memory device of the analysis server 103 may form a processing module. A processor may include a microprocessor, an application-specific integrated circuit (ASIC), a field-programmable gate array (FPGA), etc., or combinations thereof. The instructions may include code from any suitable computer programming language such as, but not limited to, ActionScript®, C, C++, C#, ECMAScript®, Hyptertext Markup Language (HTML), Java®, JavaScript®, ECMAScript®, Mathematica®, Matlab®, Perl®, Python®, R, SAS®, SPSS®, Stata®, Visual Basic®, and Extensible Markup Language (XML). The one or more processors may execute the instructions to build a structural time-series model from a time-series data and a database of global calendars. In systems 100 with more than one analysis servers 103, a first analysis server 103a may assign one or more slices of the time-series data to the additional analysis servers 103b-n. Each of the additional analysis servers 103b-n may build a structural time-series model based on the assigned one or more slices. In this specification, a slice of the aggregate time-series data may be referred to as slice data or slice time-series data. In some implementations, the first analysis server 103a may build an aggregate time-series model of the time-series data. An analysis server 103 is described in greater detail in relation to FIG. 5. In some implementations, each of the additional analysis servers 103b-n may run on the same computing device as the first analysis server 103a, as a unique virtual machine, process, or thread, on a same processor or a different processor or core. In some implementations, an analysis server 103 and the analysis server client device 102 are on a same computing device, and analysis software described in relation to FIGS. 3-5 is executed on the same computing device. In some implementations, the analysis software may also be referred to as analytics software.

FIG. 2A is a block diagram of a data collection system 200 including a network 201, a resource server client device 202, a resource server 203, and a server monitor 204. The data collection system 200 may be part of the computer system 100 described in relation to FIG. 1. The data collection system 200 may use at least one computer network 201, which may be similar to the network 101 described in relation to FIG. 1.

The resource server client device 202 may be similar to the analysis server client device 102 described in relation to FIG. 1. The resource server client device 202 may be a user-operable electronic device that includes a data processor and memory. The resource server client device 202 may be configured to communicate with the resource server 203 via the network 201. The resource server client device 202 may request, receive, upload, update, or delete a resource from a resource server 203. The resource server client device 202 may request, for instance, a web page from the resource server 203 using a web browser over a Hyper-Text Transfer Protocol (HTTP).

The resource server 203 may be similar to the analysis server 103 described in relation to FIG. 1 and resource servers 218 as described in relation to FIG. 2B. The resource server 203 may include at least one computing device having one or more processors and memory. The resource server 203 may provide one or more resources or services to one or more resource server client devices 202. In some implementations, the resource server 203 may provide one or more of a web search service, a reporting service, an online video-sharing service, a video streaming service, an audio streaming service, an image sharing service, a file storing service, a document indexing service, a database service, a website service, an email service, a social media service, an online chat service, an online shopping service, an online advertisement auction service, or any other service or resources. In some implementations, the resource server 203 may be a group or a combination of servers (e.g., a data center, a cloud computing platform, a server farm, etc.).

The server monitor 204 may be similar to the computing device of the data collection system 105 described in relation to FIG. 1. The server monitor 203 may monitor one or more metrics associated with the resource server 203 or the resource server client device 202. The server monitor 203 may monitor or collect one or more metrics continuously over a period of time at a set interval. A metric may be latency, server load, requests, responses, processor usage and load, load balance requests, bandwidth, types of requests, custom event, and custom metric. A metric may include information on the resource server client device 202 such as location, connection type, etc. Metrics may be multi-dimensional time-series data, which may also be referred to as data cubes.

FIG. 2B is another block diagram of a data collection system 208 including a network 201, third-party content providers 210, content item management system 212, third-party content servers 214, resource server client devices 216, resource servers 218, and content item selection system 220. The data collection system 208 may use at least one computer network 201, which may be similar to the network 101 described in relation to FIG. 1.

A third-party content provider 210 may be a computing device operated by an advertiser or any other content provider. The computing device can be a data processing system or have a data processor. The third-party content provider 210 may communicate with and provide a content item to the content item management system 212. In some implementations, the third-party content provider 210 may connect with the content item management system 212 to manage the selection and serving of content items by content item selection system 220. For instance, the third-party content provider 210 may set bid values and/or selection criteria via an interface that may include one or more content item conditions or constraints regarding the serving of content items. A third-party content provider 210 may specify that a content item and/or a set of content items should be selected for and served to resource server client devices 216 having device identifiers associated with a certain geographic location or region, a certain language, a certain operating system, a certain web browser, etc. In another implementation, the third-party content provider 210 may specify that a content item or set of content items should be selected and served when a resource, such as a web page, document, an application, etc., includes content item that matches or is related to certain keywords, phrases, etc. The third-party content provider 210 may set a single bid value for several content items, set bid values for subsets of content items, and/or set bid values for each content item. The third-party content provider 210 may also set the types of bid values, such as bids based on whether a user clicks on the third-party content item, whether a user performs a specific action based on the presentation of the third-party content item, whether the third-party content item is selected and served, and/or other types of bids.

The content item may be provided by the third-party content provider 210 to the content item management system 212. The content item may be in any format or type that may be presented on a resource server client device 216. The content item may also be a combination or hybrid of the formats. The content item may be specified as one of different format or type, such as text, image, audio, video, multimedia, etc. The content item 405 may be a banner content item, interstitial content item, pop-up content item, rich media content item, hybrid content item, Flash® content item, cross-domain iframe content item, etc. embedded information such as hyperlinks, metadata, links, machine-executable instructions, annotations, etc. The content item may indicate a URL that specifies a web page or a resource to which the resource server client device 216 will be redirected. The content item may include embedded instructions, and/or machine-executable code instructions. The instructions may be executed by the web browser when the content item is displayed on the resource server client device 216.

The third-party content provider 210 may provide contact information along with the content item. In some implementations, the contact information may be included or associated with the content item. Contact information may be a phone number, instant messaging handle, or any other contact information that allows interaction between the resource server client device 216 and the third-party content provider 210.

A content item management system 212 can be a data processing system. The content item management system 212 can include at least one logic device, such as a computing device having a data processor, to communicate via the network 201, for instance with the third-party content providers 210, the third-party content servers 214, and the content item selection system 220. The content item management system 212 may be combined with or include one or more of the third-party content servers 214, the content item selection system 220, or the resource server 218. The one or more processors may be configured to execute instructions stored in a memory device to perform one or more operations described herein. In other words, the one or more data processors and the memory device of the content item management system 212 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, ECMAScript®, Hyptertext Markup Language (HTML), Java®, JavaScript®, ECMAScript®, Mathematica®, Matlab®, Perl®, Python®, R, SAS®, SPSS®, Stata®, Visual Basic®, and Extensible Markup Language (XML). In addition to the processing circuit, the content item management system 110 may include one or more databases configured to store data. A data storage device may be connected to the content item management system 212 through the network 201.

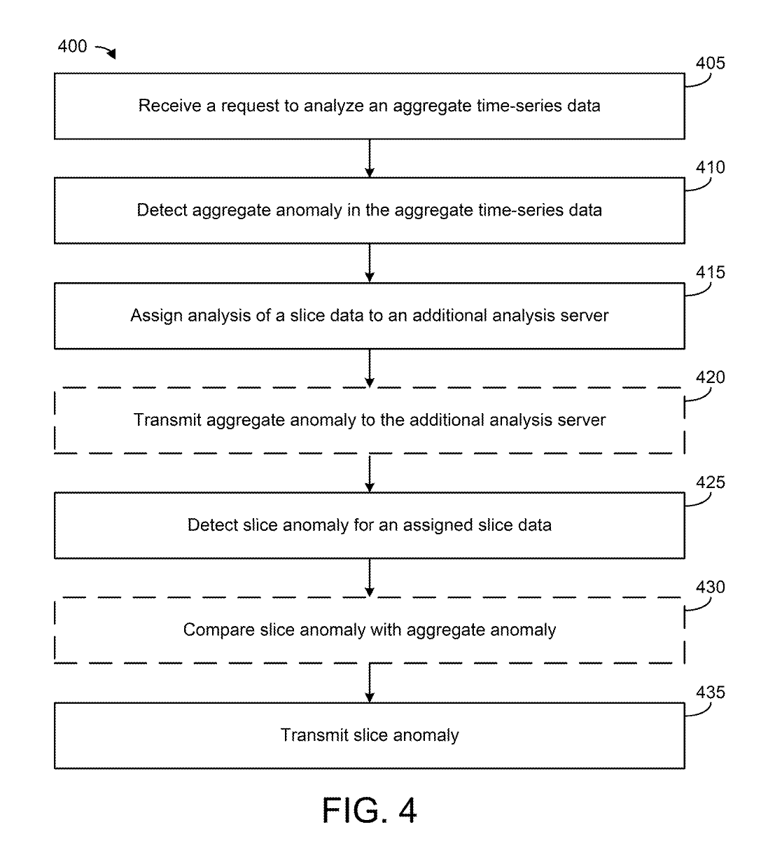

The content item management system 212 may receive the content item from one or more third-party content providers 210. The content item management system 212 may store the content item in the memory and/or the one or more databases. The content item management system 212 may provide the content item to the third-party content server 214 via the network 201. In operation, the content item management system 212 may associate a string with a content item. The content item management system 212 is described in greater detail in relation to FIGS. 4A and 4B.

The third-party content server 214 can include a computing device configured to store content items. The third-party content server 214 may be a computer server (e.g., a file transfer protocol (FTP) server, a file sharing server, a web server, a database server, etc.), a group or a combination of servers (e.g., a data center, a cloud computing platform, a server farm, etc.). The third-party content server 214 may be any type of a computing device that includes a memory element configured to store content items and associated data. The third-party content servers 214 may include any type of non-volatile memory, media, or memory devices. For instance, third-party content servers 214 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks. In some implementations, third-party content servers 214 are local to content item management system 212, content item selection system 220, or resource server 218. In other implementations, third-party content servers 214 are remote data storage devices connected with content item management system 212 and/or content item selection system 220 via network 201. In some implementations, third-party content servers 214 are part of a data storage server or system capable of receiving and responding to queries from content item management system 212 and/or content item selection system 220. In some instances, the third-party content servers 214 may be integrated into the content item management system 212 or the content item selection system 220.

The third-party content server 214 may receive content items from the third-party content provider 210 or from the content item management system 212. The third-party content server 214 may store a plurality of third-party content items that are from one or more third-party content providers 210. The third-party content server 214 may provide content items to the content item management system 212, resource server client devices 216, resource servers 218, content item selection system 220, and/or to other computing devices via network 201. In some implementations, the resource server client devices 216, resource servers 218, and content item selection system 220 may request content items stored in the third-party content servers 214. The third-party content server 214 may store a content item with information identifying the third-party content provider, identifier of a set of content items, bid values, budgets, other information used by the content item selection system 220, impressions, clicks, and other performance metrics. The third-party content server 214 may further store one or more of client profile data, client device profile data, accounting data, or any other type of data used by content item management system 212 or the content item selection system 220.

The resource server client device 216 may include any number and/or type of user-operable electronic device. For instance, a resource server client device 216 may include a desktop computer, laptop, smart phone, wearable device, smart watch, tablet, personal digital assistant, set-top box for a television set, smart television, gaming console device, mobile communication device, remote workstation, client terminal, entertainment console, or any other device configured to communicate with other devices via the network 201. The resource server client device 216 may be capable of receiving a resource from a resource server 218 and/or a content item from the content item selection system 220, the third-party content server 214, and/or the resource servers 218. The resource server client device 216 may be any form of electronic device that includes a data processor and a memory. The memory may store machine instructions that, when executed by a processor, cause the processor to request a resource, load the resource, and request a content item. The memory may also store data to effect presentation of one or more resources, content items, etc. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, ECMAScript®, Hyptertext Markup Language (HTML), Java®, JavaScript®, ECMAScript®, Mathematica®, Matlab®, Perl®, Python®, R, SAS®, SPSS®, Stata®, Visual Basic®, and Extensible Markup Language (XML). The resource server client device 216 may include an interface element (e.g., an electronic display, a touch screen, a speaker, a keyboard, a pointing device, a mouse, a microphone, a printer, a gamepad, etc.) for presenting content to a user, receiving user input, or facilitating user interaction with electronic content (e.g., clicking on a content item, hovering over a content item, etc.).

The resource server client device 216 can request, retrieve, and display resources and content items. The resource server client device 216 can execute a software application (e.g., a web browser, a video game, a chat program, a mobile application, or other application) to request and retrieve resources and contents from the resource server 218 and/or other computing devices over network 201. Such an application may be configured to retrieve resources and first-party content from a resource server 218. The first-party content can include text, image, animation, video, and/or audio information. In some cases, an application running on the resource server client device 216 may itself be first-party content (e.g., a game, a media player, etc.). The first-party content can contain third-party content or require the resource server client device 216 to request a third-party content from a third-party content server 214. The resource server client device 216 may display the retrieved third-party content by itself or with the resources or the first-party content on the user interface element. In some implementations, the resource server client device 216 includes an application (e.g., a web browser, a resource renderer, etc.) for converting electronic content into a user-comprehensible format (e.g., visual, aural, graphical, etc.).

The resource server client device 216 may execute a web browser application to request, retrieve and display first-party resources and content items. The web browser application may provide a browser window on a display of the resource server client device 216. The web browser application may receive an input or a selection of a URL, such as a web address, from the user interface element or from a memory element. In response, one or more processors of the resource server client device 216 executing the instructions from the web browser application may request data from another device connected to the network 201 referred to by the URL address (e.g., a resource server 218). The computing device receiving the request may then provide web page data and/or other data to the resource server client device 216, which causes visual indicia to be displayed by the user interface element of the resource server client device 216. Accordingly, the browser window displays the retrieved first-party content, such as a web page from a website, to facilitate user interaction with the first-party content. The resource server client device 216 and/or the agent may function as a user agent for allowing a user to view HTML encoded content.

The web browser on the resource server client device 216 may also load third-party content along with the first-party content in the browser window. Third-party content may be a third-party content item. In some instances, the third-party content may be included within the first-party resource or content. In other instances, the first-party resource may include one or more content item slots. Each of the content item slots may contain embedded information (e.g. meta information embedded in hyperlinks, etc.) or instructions to request, retrieve, and load third-party content items. The content item slot may be a iframe slot, an in-page slot, and/or a JavaScript® slot. The web browser may process embedded information and execute embedded instructions. The web browser may present a retrieved third-party content item within a corresponding content item slot.

In some implementations, the resource server client device 216 may detect an interaction with a content item. An interaction with a content item may include displaying the content item, hovering over the content item, clicking on the content item, viewing source information for the content item, or any other type of interaction between the resource server client device 216 and a content item. Interaction with a content item does not require explicit action by a user with respect to a particular content item. In some implementations, an impression (e.g., displaying or presenting the content item) may qualify as an interaction. The criteria for defining which inputs or outputs (e.g., active or passive) qualify as an interaction may be determined on an individual basis (e.g., for each content item) by content item selection system 220 or by content item management system 212.

The resource server client device 216 may generate a variety of user actions responsive to detecting an interaction with a content item. The generated user action may include a plurality of attributes including a content identifier (e.g., a content ID or signature element), a device identifier, a referring URL identifier, a timestamp, or any other attributes describing the interaction. The resource server client device 216 may generate user actions when particular actions are performed by a resource server client device 216 (e.g., resource views, online purchases, search queries submitted, etc.). The user actions generated by the resource server client device 216 may be communicated to a content item management system 212 or a separate accounting system.

The resource server 218 can include a computing device, such as a database server, configured to store resources and content items. A computing device may be a computer server (e.g., a file transfer protocol (FTP) server, a file sharing server, a web server, a database server, etc.), a group or a combination of servers (e.g., a data center, a cloud computing platform, a server farm, etc.). The resource server 218 may be any type of a computing device that includes a memory element configured to store resources, content items, and associated data. The third-party content servers 214 may include any type of non-volatile memory, media, or memory devices. For instance, the resource server 218 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks.

The resource server 218 may be configured to host resources. Resources may include any type of information or data structure that can be provided over network 201. Resources provided by the resource server 218 may be categorized as local resources, intranet resources, Internet resources, or other network resources. Resources may be identified by a resource address associated with the resource server 218 (e.g., a URL). Resources may include web pages (e.g., HTML web pages, PHP web pages, etc.), word processing documents, portable document format (PDF) documents, text documents, images, music, video, graphics, programming elements, interactive content, streaming video/audio sources, comment threads, search results, information feeds, or other types of electronic information. In some implementations, one resource server 218 may host a publisher web page or a search engine and another resource server 218 may host a landing page, which is a web page indicated by a URL provided by the third-party content provider 210.

Resources hosted by the resource server 218 may include a content item slot, and when the resource server client device 216 loads the resource, the content item slot may instruct the resource server client device 216 to request a content item from a content item selection system 220. In some implementations, the request may be part of a web page or other resource (such as, for instance, an application) that includes one or more content item slots in which a selected and served third-party content item may be displayed. The code within the web page or other resource may be in JavaScript®, ECMAScript®, HTML, etc, and define a content item slot. The code may include instructions to request a third-party content item from the content item selection system 220 to be presented with the web page. In some implementations, the code may include an image request having a content item request URL that may include one or more parameters (e.g., /page/contentitem?devid=abc123&devnfo=A34r0). Such parameters may, in some implementations, be encoded strings such as “devid=abc123” and/or “devnfo=A34r0.”

The content item selection system 220 can include at least one logic device, such as a computing device having a data processor, to communicate via the network 201, for instance with a third-party content provider 210, the content item management system 212, the third-party content server 214, the resource server client device 216, and the resource server 218. In some implementations, the content item selection system 220 may be combined with or include the third-party content servers 214, the content item management system 212, or the resource server 218.

The content item selection system 220, in executing an online auction, can receive, via the network 201, a request for a content item. The received request may be sent from a resource server 218, a resource server client device 216, or any other computing device in the system 100. The received request may include instructions for the content item selection system 220 to provide a content item with the resource. The received request can include client device information (e.g., a web browser type, an operating system type, one or more previous resource requests from the requesting device, one or more previous content items received by the requesting device, a language setting for the requesting device, a geographical location of the requesting device, a time of a day at the requesting device, a day of a week at the requesting device, a day of a month at the requesting device, a day of a year at the requesting device, etc.) and resource information (e.g., URL of the requested resource, one or more keywords associated with the requested resource, text of the content of the resource, a title of the resource, a category of the resource, a type of the resource, etc.). The information that the content item selection system 220 receives can include a HyperText Transfer Protocol (HTTP) cookie which contains a device identifier (e.g., a random number) that represents the resource server client device 216. In some implementations, the device information and/or the resource information may be appended to a content item request URL (e.g., contentitem.item/page/contentitem?devid=abc123&devnfo=A34r0). In some implementations, the device information and/or the resource information may be encoded prior to being appended the content item request URL. The requesting device information and/or the resource information may be utilized by the content item selection system 220 to select third-party content items to be served with the requested resource and presented on a display of a resource server client device 216. The selected content item may be marked as eligible to participate in an online auction.

Content item selection system 220, in response to receiving the request, may select and serve third-party content items for presentation with resources provided by the resource servers 218 via the Internet or other network. The content item selection system 220 may be controlled or otherwise influenced by a third-party content provider 210 that utilizes a content item management system 212. For instance, a third-party content provider 210 may specify selection criteria (such as keywords) and corresponding bid values that are used in the selection of the third-party content items. The bid values may be utilized by the content item selection system 220 in an auction to select and serve content items for presentation with a resource. For instance, a third-party content provider may place a bid in the auction that corresponds to an agreement to pay a certain amount of money if a user interacts with the provider's content item (e.g., the provider agrees to pay $3 if a user clicks on the provider's content item). In other instances, a third-party content provider 210 may place a bid in the auction that corresponds to an agreement to pay a certain amount of money if the content item is selected and served (e.g., the provider agrees to pay $0.005 each time a content item is selected and served or the provider agrees to pay $0.05 each time a content item is selected or clicked). In some instances, the content item selection system 220 uses content item interaction data to determine the performance of the third-party content provider's content items. For instance, users may be more inclined to click on third-party content items on certain webpages over others. Accordingly, auction bids to place the third-party content items may be higher for high-performing webpages, categories of webpages, and/or other criteria, while the bids may be lower for low-performing webpages, categories of webpages, and/or other criteria.

In some implementations, content item selection system 220 may determine one or more performance metrics for the third-party content items and the content item management system 212 may provide indications of such performance metrics to the third-party content provider 210 via a user interface. For instance, the performance metrics may include number of clicks, a cost per impression (CPI) or cost per thousand impressions (CPM), where an impression may be counted, for instance, whenever a content item is selected to be served for presentation with a resource. In some instances, the performance metric may include a click-through rate (CTR), defined as the number of clicks on the content item divided by the number of impressions. In some instances, the performance metrics may include a cost per engagement (CPE), where an engagement may be counted when a user interacts with the content item in a specified way. An engagement can be sharing a link to the content item on a social networking site, submitting an email address, taking a survey, or watching a video to completion. Still other performance metrics, such as cost per action (CPA) (where an action may be clicking on the content item or a link therein, a purchase of a product, a referral of the content item, etc.), conversion rate (CVR), cost per click-through (CPC) (counted when a content item is clicked), cost per sale (CPS), cost per lead (CPL), effective CPM (eCPM), and/or other performance metrics may be used. The various performance metrics may be measured before, during, or after content item selection, content item presentation, click, or user engagement. The various performance metrics may be stored as time-series data. In some implementations, each time-series data may also include platform and/or geographic location of each client device.

The content item selection system 220 may select a third-party content item to serve with the resource based on performance metrics and/or several influencing factors, such as a predicted click through rate (pCTR), a predicted conversion rate (pCVR), a bid associated with the content item, etc. Such influencing factors may be used to generate a value, such as a score, against which other scores for other content items may be compared by the content item selection system 220 through an auction. Influencing factors may be stored as time-series data.

During the auction for a content item slot for a resource, content item selection system 220 may utilize several different types of bid values specified by third-party content providers 210 for various third-party content items. For instance, an auction may include bids based on whether a user clicks on the third-party content item, whether a user performs a specific action based on the presentation of the third-party content item, whether the third-party content item is selected and served, and/or other types of bids. For instance, a bid based on whether the third-party content item is selected and served may be a lower bid (e.g., $0.005) while a bid based on whether a user performs a specific action may be a higher bid (e.g., $5). In some instances, the bid may be adjusted to account for a probability associated with the type of bid and/or adjusted for other reasons. For instance, the probability of the user performing the specific action may be low, such as 0.2%, while the probability of the selected and served third-party content item may be 100% (e.g., the selected and served content item will occur if it is selected during the auction, so the bid is unadjusted). Accordingly, a value, such as a score or an normalized value, may be generated to be used in the auction based on the bid value and the probability or another modifying value. In the prior instance, the value or score for a bid based on whether the third-party content item is selected and served may be $0.005*1.00=0.005 and the value or score for a bid based on whether a user performs a specific action may be $5*0.002=0.01. To maximize the income generated, the content item selection system 220 may select the third-party content item with the highest value from the auction. In the foregoing instance, the content item selection system 220 may select the content item associated with the bid based on whether the user performs the specific action due to the higher value or score associated with that bid.

Once the content item selection system 220 selects a third-party content item, data to effect presentation of the third-party content item on a display of the resource server client device 216 may be provided to the resource server client device 216 using a network 201. A user on the resource server client device 216 may select or click on the provided third-party content item. In some instances, a URL associated with the third-party content item may reference another resource, such as a web page or a landing page. In other instances, the URL may reference back to the content item selection system 220, a third-party content server 214, a content item management system 212, or a click server as described below. The resource server client device 216 may send a request using the URL, and one or more performance metrics are updated, such as a click-thru or engagement. The resource server client device 216 is redirected to a resource, such as a web page or a landing page, that has been provided by a third-party content provider 210 along with the content item.

In some implementations, the content item selection system 220 can include a click server. The click server may measure, store, or update performance metrics associated with the content item and/or the third-party content provider 210. The click server may be part of the content item management system 212, content item selection system 220, or another computing device connected to the network 201. In some implementations, the click server receives a request from a resource server client device 216 when the user interacts with the content item that the resource server client device 216 receives from the content item selection system 220 or the third-party content server 214. For instance, a user on the resource server client device 216 may interact with a content item by clicking the content item, and the user may be redirected to a click page stored on the click server. In some implementations, the click server receives a request from a resource server client device 216 when the user uses the provided contact information to contact the click server. For instance, the user may call the phone number that is provided with the content item. After the click server receives a request, the click server may record an interaction with the content item. After recording the interaction, the click server may update a performance metric stored in the content item management system 212, the third-party content server 214, or the content item selection system 220, where the performance metric is associated with a content item that was loaded on the resource server client device 216. For instance, the metric may be a user engagement with an advertisement. The click server may redirect the resource server client device 216 to a resource that is stored in a resource server 218, wherein the resource may be the landing page that is indicated by the URL provided by the third-party content provider 210 and associated with the content item.

In an illustrative instance, a resource server client device 216 using a web browser can browse to a web page provided by a web page publisher. The web page publisher may be the first-party content provider and the web page may be the first-party content. The web page can be provided by a resource server 218. The resource server client device 216 loads the web page which contains a third-party content item, such as an ad. In some implementations, the resource server 218 may receive an ad from an ad server and provide the ad with the web page to a resource server client device 216. The ad server may be a third-party content server 214. In some implementations, the web page publisher may provide search engine results and the ads may be provided with the search results. In some implementations, the web page may contain a link that either directly or indirectly references an ad server. For instance, as a web browser on a client device loads the web page, the client device requests the ad and receives it from the ad server. The ad server receives the ad from an advertiser. The advertiser may be a third-party content provider 106. The advertiser may create or provide information to generate the ad. The ad may link to a landing page which can be another web page or resource. The link can be provided by the advertiser. The ad can also include advertiser's contact information. In some implementations, the ad may link to a click server that updates performance metrics associated with the ad and redirects the resource server client device 216 to the landing page. In some implementations, the ad can include a contact information such as phone number, that may be dialed by the user of the resource server client device 216. When the user dials the contact phone number, a performance metric may be updated.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content item from the content server that may be more relevant to the user. In addition, certain data may be treated (e.g., by content item selection system 220) in one or more ways before it is stored or used, so that personally identifiable information is removed. For instance, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by resource server client devices 216, etc.) and used by content item selection system 220.

FIG. 3 depicts one implementation of a process for detecting an anomaly in a time-series data 300. In brief overview, the method generally includes receiving a request to analyze a time-series data (step 305), accessing a database of global calendars (step 310), and building a structural time-series model (step 315). The method further includes determining, for each data point, a range of expected values from the model (step 320), detecting an anomaly at a data point lying outside the respective range (step 325), and transmitting the anomaly to the client for display (step 330). The method may optionally include generating forecast values from the model (step 335) and transmitting the forecast values for display (step 340).

Still referring to FIG. 3, and in more detail, the method includes receiving a request to analyze a time-series data (step 305). The request may include a time-series data or a time-series data identifier. The time-series data may comprise a plurality of data points. In implementations that includes a time-series data identifier, the identifier may be used to retrieve the time-series data from a memory element or from a computing device such as the data collection system 105 in FIG. 1. The time-series data may be an aggregate time-series data or a slice data. A slice data is a portion of the aggregate time-series data that has at least one fixed value for one or the dimensions of the data. For instance, the aggregate time-series data may be total number of clicks as described in relation to FIG. 2B, and the data may be divided into a dimension of platform of a device from which the click is generated. The platform may be a laptop, a desktop, or a mobile device. One slice of the aggregate time-series data may have a fixed value of laptop, such that all time-series data from the aggregate that has the value of laptop may be part of the slice. Another slice may have the value of desktop, and another slice may have the value of mobile devices.

In some implementations, the request may be sent from an analysis server client device 102 in FIG. 1 and received at a first analysis server 103a. In some implementations, the first analysis server 103a may perform each analysis of a slice of the time-series data as well as an analysis of the aggregate time-series data.

In some implementations, the request may be sent from a first analysis server 103a and received at one or more additional analysis servers 103b-n. In such implementations, the first analysis server 103a may send a request to one or more additional analysis servers 103b-n with a slice of the time-series data to parallelize the analysis. The first analysis server 103 may analyze the aggregate time-series data, or assign the analysis of the aggregate time-series data to one of the additional analysis servers 103b-n. The process for parallelizing the time-series analysis is described in further detail in relation to FIG. 4.

The request may also include a range of time to analyze. The range of time may include a start time and an end time. For instance, the range of time may be from Nov. 1, 2013 to Jan. 1, 2014. The range of time may be anywhere from a few seconds to several years. In some implementations, the range of time may be determined from the time-series data. In some implementations, a default range of time may be used. For instance, all available time-series data may be used. In some implementations, the default range of time may include any time-series data later than a predefined duration before the current time.

The request may also include a time resolution, which may specify a level at which the analysis is to be performed. For instance, a resolution of ten seconds will perform the analysis by splitting the time-series data into ten second intervals. The time resolution may range from a microsecond to a few years, and is less than the range of time. In some implementations, the time resolution is determined from the range of time and/or from the time-series data. In some implementations, the time resolution of the time-series data is used. In some implementations, a default time resolution may be used.

The request may also include an anomaly parameter. The anomaly parameter may include a percentage value or a standard deviation multiplier. For any given data point, a range of expected values may be calculated from the percentage value or the standard deviation multiplier. The time-series model will generate a mean and a standard deviation for each data point. The percentage value or the standard deviation multiplier may be used with the mean and the standard deviation to determine whether the data point lies outsides the range of expected values. In some implementations, a positive standard deviation multiplier value may indicate a deviation greater than the mean, and a negative standard deviation multiplier value may indicate a deviation lesser than the mean. In some implementations, a percentage value or a percentile value of 50% is equal to the mean. A percentage or percentile value less than 50% is lesser than the mean, and a percentage or percentile value greater than 50% is greater than the mean. A person having the skilled in the art will recognize that other ways of representing deviation from a mean value may be used.

The request may also include a rule or a set of rules for alerts. A rule may include a threshold component, a time component, and an action component. The threshold may include a percentage or a standard deviation multiplier, similar to the standard deviation multiplier. A rule may be used to detect tail-end probabilities that are either above or below the mean. A rule may further include generating an alert only for values that are above the mean or generating an alert only for values that are below the mean. In other words, a rule may specify that an alert may be generated for values that are on one end of the Gaussian distribution but not the other. For instance, a rule may specify that a data point that is 97.9 percentile and above the expected range of values should generate an alert. A rule may also specify a time component, which may be a specific time (e.g., Dec. 24, 2013), a time range (e.g., Nov. 1, 2013 to Jan. 1, 2014), and/or a recurring time (e.g. every Saturday). The action component may specify an action to be performed when an alert is raised. In some implementations, a message may be sent via a specified contact information, such as an email, a call, a text message, or a notification. In some implementations, an alert is annotated on the report of the time-series data that is generated. In some implementations, an action component may specify that an anomaly may only be detected if it satisfies the threshold and the time components of the rule.

In some implementations, the request may optionally include forecast parameters. The forecast parameters may include whether to generate forecast values and the duration to generate forecast values. The duration may specify a time range that starts from the last time-series data. Forecast values are generated for that time range specified by the duration. The forecast parameters are described in relation to optional step 335.

As shown in FIG. 3, the method further includes accessing a database of global calendars (step 310). The database may be stored in an events database 104 as described in relation to FIG. 1. The database of global calendars may include one or more lists or matrices. In some implementations, each of the one or more matrices may be associated with a geographical identifier. A request may be sent to the database and in some implementations, the request may include a geographic identifier. The list or matrix that is associated with the geographic identifier included in the request may be accessed. In some implementations, the list or matrix may be a default list or matrix. In implementations where a list is access, a matrix may be generated from the accessed list based on a granularity of the time-series data. In some implementations, the accessed or generated matrix may be copied to a memory element of a computing device, e.g. a server.

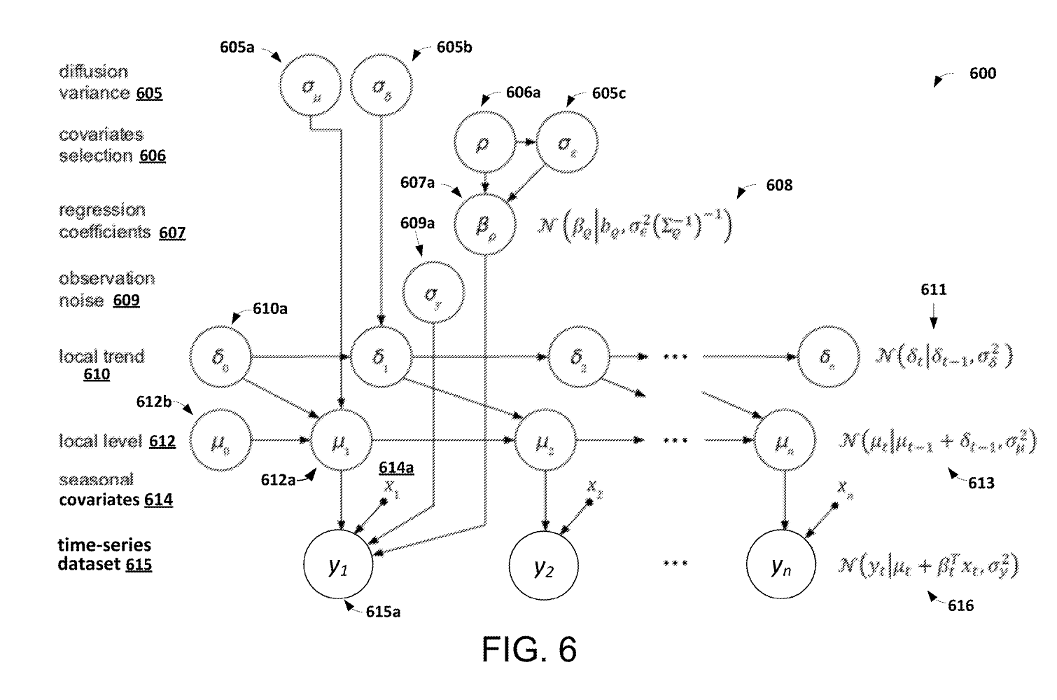

As shown in FIG. 3, the method further includes building a structural time-series model (step 315). In some implementations, the model includes building a dynamic linear model, a state-space model, and/or a Bayesian time-series model. The structural time-series model may be built from the time-series data and the database of global calendars. The structural time-series model may be a Bayesian structural time-series (BSTS) model. In other implementations, a maximum-likelihood solution, a Laplace approximation, or a variational approximation may be used. The structural time-series model may be a linear or a non-linear time series model. In some implementations, the structural time-series model may be in a state-space form and may include an associated Kalman filter. In some implementations, the model may be a non-stationary model. In some implementations, the model may include a smoother. In some implementations, a predefined time budget may be defined for the model. One implementation of the Bayesian structural time-series model is described in greater detail in relation to FIG. 6.

As shown in FIG. 3, the method further includes determining, for each data point, a range of expected values from the model (step 320). In some implementations, the range of expected values may be determined by the mean and the standard deviation value generated by the model for each data point. In some implementations, the anomaly parameter may be used with the mean and the standard deviation to calculate the range of expected values for each data point. For instance, the anomaly parameter may specify three standard deviations on each side of the mean. The minimum value for the range of expected values may be the mean minus three times the standard deviation, and the maximum value may be the mean plus three times the standard deviation.

As shown in FIG. 3, the method further includes detecting an anomaly at a data point lying outside the respective range of expected values (step 325). The data point may be referred to as a first data point, and may be any one of the plurality of data points. The anomaly may correspond to the data point. In some implementations, a plurality of anomalies may be detected, each anomaly corresponding to a respective data point that lies outside a respective range of expected values. In some implementations, an anomaly parameter or a rule or a set of rules may be used to detect an anomaly. In some implementations, the anomaly parameter may be used to determine one or more anomalies, and a rule or a set of rules may be applied to each of the one or more anomalies. In some implementations, the anomaly parameter and the rule or a set of rules may be applied to the model independently.

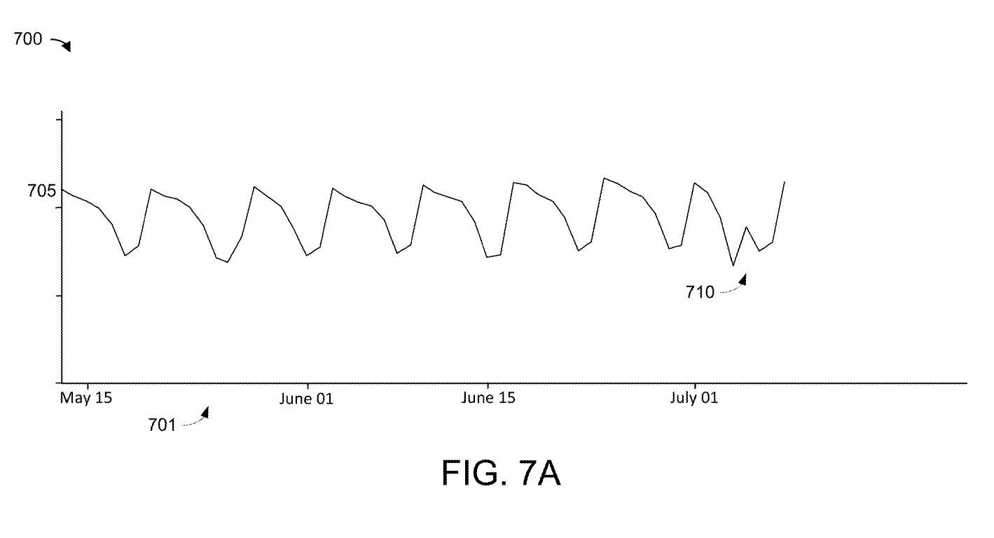

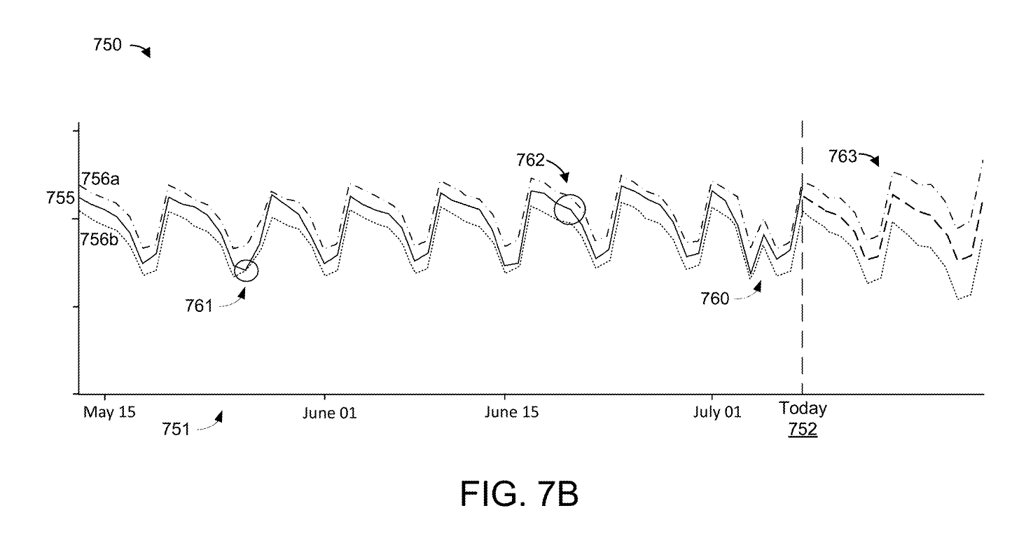

As shown in FIG. 3, the method further includes transmitting the anomaly to the client for display (step 330). In some implementations, the range of expected values corresponding to the anomaly may also be transmitted to the client for display. In some implementations, a plurality of anomalies may be transmitted, and a plurality of range of expected values, each corresponding to a respective anomaly, may also be transmitted. In some implementations, anomaly may be transmitted as a report. For instance, the report may include a visual representation, such as a graph, of the time series data, the range of expected values at each data point, and an indication of data points at which an anomaly was detected. The report may also include that an anomaly is not visible on the graph (i.e. the data point lies within the range of expected values) and suggest that the anomaly will be visible on a graph of a slice of the time-series data. A report is further described in relation to FIG. 7B.

In some implementations, the anomaly may be transmitted to a first analysis server 103a if the analysis is performed from an additional analysis server 103b-n. The anomaly that was detected in step 325 will be an anomaly in the slice data.

As shown in FIG. 3, the method further optionally includes generating forecast values from the model (step 335). Forecast values may include one or more values corresponding to one or more times that are not part of the time-series data. Forecast parameters may indicate whether to generate forecast values. The forecast parameters may also include a duration. In one instance, the duration may be a day. In another instance, the duration may be a week. The duration specifies a time range that starts from the last time-series data. For instance, the time-series data may include data from Nov. 1, 2013 to Jan. 1, 2014. If the duration is a week, forecast values may be generated for a time range of Jan. 2, 2014 to Jan. 9, 2014. Forecast values may be generated for each time interval of a time resolution used by the model. For instance, the model may use a time resolution of one day, and the forecast values may be for a week and may include seven values, each value corresponding to one day of the week. The model may also generate a mean and a standard deviation for each forecast value. The mean and the standard deviation may be used to generate a range of expected values for each forecast values.

As shown in FIG. 3, the method further optionally includes transmitting the forecast values for display (step 340). The forecast values may be displayed with the time-series data. Each forecast value may be displayed with respective range of expected values. In some implementations, the forecast values may be displayed on a graph as a report, and the report may visually distinguish the forecast values from the time-series data. Displaying forecast values is described in relation to FIG. 7B.

FIG. 4 depicts one implementation of a process 400 for parallelizing the time-series analysis. In brief overview, the method generally includes receiving a request to analyze an aggregate time-series data (step 405), detecting aggregate anomaly in the aggregate time-series data (step 410), and assigning analysis of a slice data to an additional analysis server (step 415). The method also includes detecting slice anomaly for an assigned slice data (step 425) and transmitting slice anomaly (step 435). The method optionally includes transmitting aggregate anomaly from the time-series data to additional analysis servers (step 420) and comparing slice anomaly with aggregate anomaly (step 430).

Still referring to FIG. 4, and in more detail, the method includes receiving a request to analyze an aggregate time-series data (step 405). The request may be received at the first analysis server 103a in FIG. 1. The request may indicate that the time-series analysis should be parallelized. The request may include an aggregate time-series data or an identifier to the aggregate time-series data. In some implementations, the aggregate time-series data may be a multi-dimensional time-series data, also referred to as data cubes. The request may include which dimension of the aggregate time-series data to parallelize. For instance, the aggregate time-series data may be number of clicks for a content item as described in relation to FIG. 2B, and dimensions may include device type, geographic region, and language setting for the requesting device. The request to analyze a time-series data may include an indication that the aggregate time-series data should be parallelized by the device type dimension, such that each slice data will have a unique device type. In some implementations, more than one dimension may be selected. In some implementations, no dimension is selected. In some implementations, all dimensions are analyzed in parallel. The aggregate time-series data and/or the slice data may be stored on the data collection system 105 or any of the analysis servers 103 in FIG. 1.

As shown in FIG. 4, the method further includes detecting an aggregate anomaly in the aggregate time-series data (step 410). Detecting an anomaly is described in relation to steps 310 through steps 325 of FIG. 3. In this specification, “aggregate anomaly” refers to anomalies that are detected in the aggregate time-series data. In some implementations, more than one aggregate anomalies are detected. In some implementations, the detected anomalies are stored in a memory element. In some implementations, the analysis of aggregate time-series data is assigned to another analysis server and aggregate anomalies are received from that server.

As shown in FIG. 4, the method further includes assigning analysis of a slice data to an additional analysis server (step 415). Each slice data may be generated from and may be a portion of the aggregate data. The slice data may be generated based on one or more specified dimensions of the data or based on all dimensions of the data. For one dimension, there may be a plurality of slice data, each slice data having a unique value along that dimension. Analysis of a slice may be assigned to an additional analysis server 103b-n. In some implementations, more than one analysis corresponding to more than one slice may be assigned to an additional analysis server 103b-n. Assigning the analysis may include sending a request to an additional analysis server 103b-n, which may receive the request and detect an anomaly in the slice data as described in relation to step 305 through step 330 in FIG. 3.

As shown in FIG. 4, the method optionally includes transmitting aggregate anomaly from the time-series data to the additional analysis server (step 420). In some instances, a plurality of aggregate anomalies may be transmitted. In some implementations, an aggregate anomaly includes a time at which an anomaly is detected using the aggregate time-series data. An aggregate anomaly may further include characteristics of the aggregate anomaly, such as a percentile or a standard deviation multiplier. For instance, the aggregate anomaly may specify that the number of clicks, as described in a system in FIG. 2B, is three standard deviations above the mean. In another instance, the aggregate anomaly may specify that the number of clicks is in the 2% percentile, and thus below the mean.

As shown in FIG. 4, the method further includes detecting a slice anomaly for an assigned slice data (step 425). In this specification, slice anomaly refers to anomaly detected from the slice data, or the slice of the time-series data. Detecting a slice anomaly may be similar to detecting an aggregate anomaly as describe in step 410, and as described in relation to relation to steps 310 through steps 325 of FIG. 3. The slice anomaly may be detected at one of the additional analysis servers 103b-n in FIG. 1, that was assigned the corresponding slice data by the first analysis server 103a.

As shown in FIG. 4, the method optionally includes comparing slice anomaly with aggregate anomaly (step 430). In some implementations, comparing slice anomaly with aggregate anomaly may be referred to as combining slice anomaly with aggregate anomaly. The comparison may be performed at the first analysis server 103a or by the additional analysis server 103b-n that detected the slice anomaly. In implementations where the first analysis server 103a performs the comparison, the slice anomaly is transmitted from the additional analysis server to the first analysis server 103a. In implementations where the additional analysis server 103b-n performs the comparison, the aggregate anomaly is transmitted to the additional analysis server 103b-n as described in relation to step 420. In some implementations, each of the aggregate slice anomalies are compared to each of the plurality of aggregate anomalies.

The comparison may include matching a time of the slice anomaly with a time of the aggregate anomaly. If the time of the slice anomaly equals the time of the aggregate anomaly, a match is detected. In some implementations, the comparison may include determining whether the time of the slice anomaly is proximate to the time of the aggregate anomaly. The proximity may be determined by, for instance, time resolution or interval of the model or the time-series data, as compared to a difference in time of the aggregate anomaly and the slice anomaly. If the time resolution or interval is too small compared to the difference in time, then the times will not be considered a match. If the time resolution interval is big enough compared to the difference in time, then the times may be considered to match. In some implementation, the time difference needs to be less than three times the time resolution in order for the aggregate anomaly and the slice anomaly to be considered a match. For instance, the time resolution of the time-series data may be four hours, which means that each data point may be less than twelve hours apart for the anomalies to be considered to match. In other implementations, the time difference needs to be zero.

The comparison may further include determining whether the slice anomaly is similar to the aggregate anomaly. The similarity of the slice anomaly and the aggregate anomaly may be determined in one of several ways. In one implementation, both the slice anomaly and the aggregate anomaly may include a standard deviation value. If the standard deviation values have the same sign, i.e. positive or negative, then the anomalies may be considered to be similar. In another implementation, both anomalies may include a percentile value. If the percentile values are both above 50% or both below 50%, then the anomalies may be considered to be similar. In other implementations, a stricter similarity of anomalies may be required. For instance, the difference in percentile values of aggregate anomaly and the slice anomaly may need to be below a predefined value, for instance 1%. Or, the difference in standard deviation values must be below some predefined number, such as 0.2. In other implementations, no similarity may be required in comparing the slice anomaly to the aggregate anomaly.

As shown in FIG. 4, the method further includes transmitting the slice anomaly (step 435). In implementations where the slice anomaly is compared with the aggregate anomaly (step 430), the slice anomaly is transmitted based on the comparison. For instance, if the comparison shows that the time of the slice anomaly is similar to the time of the aggregate anomaly and if the anomalies are similar, then the slice anomaly is transmitted. In some implementations, the slice anomaly may be transmitted with the slice data to be displayed with the slice data. In some implementations, the slice anomaly may be combined with the aggregate anomaly. In some implementations, the slice anomaly may be transmitted with the aggregate anomaly and the aggregate data to be displayed together. The slice anomaly may be transmitted to the analysis server client device 102 as described in FIG. 1. In some implementations, the slice anomaly may be transmitted as a “drill-down” suggestion, which may indicate that while the slice anomaly may not be visible in the report comprising the aggregate data, the slice data will become visible in a report comprising the slice data.

FIG. 5 is a block diagram illustrating one implementation 500 of an analysis server 103 of FIG. 1 in greater detail, shown to include a processor 501, memory 502, and a network interface 503. The network interface 503 may be one or more communication interfaces that includes wired or wireless interfaces (e.g., jacks, antennas, transmitters, receivers, transceivers, wire terminals, Ethernet ports, WiFi transceivers, wireless chipset, air interface etc.) for conducting data communications with local or remote devices or systems via the network 101. For instance, the network interface 503 may allow analysis server 103 to communicate with the analysis server client device 102, the events database 104, or the data collection system 105 via the network 101. In some implementations, the network interface 503 may have a corresponding module or software that works in conjunction with hardware components. The network interface 503 may receive a request from the analysis server client device 102 and transmit an anomaly to the analysis server client device 102 or to a first analysis server 103a. The network interface 503 may receive a time-series data from the data collection system 105 and store the data in memory 502. The network interface 503 may receive a global calendar from the events database 104.

The processor 501 may be implemented as a general purpose processor, an application specific integrated circuit (ASIC), one or more field programmable gate arrays (FPGAs), a Central Processing Unit, a Graphical Processing Unit, a group of processing components, or other suitable electronic processing components. The processor 501 may be connected directly or indirectly to the memory 502 and the network interface 503. The processor 501 may read, write, delete, or otherwise access data stored in memory 502 or other components. The processor 501 may execute instructions stored in memory 502.

Memory 502 may include one or more devices (e.g., RAM, ROM, flash memory, hard disk storage, etc.) for storing data and/or computer code for completing and/or facilitating the various processes, layers, and modules described in the present disclosure. Memory 502 may include volatile memory or non-volatile memory. Memory 502 may include database components, object code components, script components, or any other type of information structure for supporting the various activities and information structures described in the present disclosure. In some implementations, memory 502 is communicably connected to processor 501 and includes computer code (e.g., data modules stored in memory 502) for executing one or more processes described herein. In brief overview, memory 502 is shown to include an time-series data 510, structural time-series module 520, an anomaly detector 530, and a report generator 550. Memory 502 may also optionally include an aggregate time-series data 511a, a slice time-series data 511b, a parallelization module 515, a rule 531, and a forecast generator 540.

Still referring to FIG. 5, memory 502 may include a request parser, which is not shown in the illustration. The request parser may receive a request to analyze a time-series data 510 via the network interface 503. The request parser may determine the different parameters that may be included in the request, such as a time-series data identifier or a time-series data, time parameters, an anomaly parameter, a rule or a set of rules for alerts, and forecast parameters. The request parser may store the parameters in memory 502.

Still referring to FIG. 5, memory 502 is shown to include time-series data 510. The time-series data 510 may be received from the network interface 503. The time-series data 510 may be a multi-dimensional data cube. The time-series data 510 may be an aggregate time-series data 511a or a slice time-series data 511b. The slice time-series data 510 may be a portion of the aggregate time-series data 511a. Time-series data 510 may comprise plurality of data points of a time resolution, or the time between each data point. Time-series data 510 may be fine-grained, or have high time resolution. Time-series data 510 may be a temporal evolution of clicks, spam events, site visits, cloud workload performance, or revenue across products, countries, or platforms.

As shown in FIG. 5, memory is shown to optionally include a parallelization module 515. In some implementations, the parallelization module 515 only operates in the first analysis server 103a of FIG. 1. The parallelization module 515 may generate one or more slice time-series data 511b from the aggregate time-series data 511a. The parallelization module 515 may assign one or more of the slice time-series data 511b to one or more additional analysis servers 103b-n of FIG. 1. In some implementations, the parallelization module 515 may assign the one or more of the slice time-series data 511b based on load of the one or more additional analysis servers 103b-n. The parallelization module 515 may send the requests and/or the slice time-series data 511b to an additional analysis server 103b-n. The parallelization module 515 may also send an indication that time of any slice anomalies should be compared against the times of any aggregate anomalies. The parallelization module 515 may receive one or more aggregate anomalies from the structural time-series module 520 and send the aggregate anomalies to the one or more additional analysis servers 103b-n. In some implementations, the parallelization module 515 may receive slice anomalies from the one or more additional analysis servers 103b-n and compare each slice anomalies to the one or more aggregate anomalies. The parallelization module 515 may determine whether to transmit a slice anomaly based on the comparison with the aggregate anomalies. For instance, if a slice anomaly occurs at the same or similar time as an aggregate anomaly, the parallelization module 515 may not transmit the slice anomaly.

As shown in FIG. 5, memory is shown to include a structural time-series module 520. In some implementations, the structural time-series module 520 may comprise a Bayesian structural time-series (BSTS) model. The BSTS model is described in further detail in relation to FIG. 6. In some implementations, the structural time-series module 520 may comprise a variational approximation. In some implementations, the module 520 uses the aggregate time-series data 511a to build a model. In other implementations, the module 520 uses the slice time-series data 511b to build a model. In yet other implementations, the module 520 uses both the aggregate and slice time-series data 511 to build two separate models.

As shown in FIG. 5, memory is shown to include an anomaly detector 530. The anomaly detector 530 may detect one or more anomalies in the time-series data 510 based on the structural time-series model of the module 520, by determining a range of expected values for each data point of the time-series data 510. The anomaly detector 530 may detect an anomaly at a data point if the data point lies outsides the corresponding rang of expected values.

In some implementations, the anomaly detector 530 may compare the detected anomaly of a slice data with the aggregate anomaly. In some implementations, the anomaly detector 530 may receive the slice anomaly if the structural time-series module 520 analyzed the aggregate time-series data 511a. In other implementations, the anomaly detector 530 may receive the aggregate anomaly if the structural time-series module 520 analyzed the slice time-series data 511b. In other implementations, the structural time-series module 520 may have analyzed both the aggregate and the slice time-series data.

As shown in FIG. 5, memory is shown to optionally include a rule 531. In some implementations, the rule 531 may be part of or used by the anomaly detector 531 to detect an anomaly. In some implementations, after the anomaly detector 530 detects one or more anomalies, a the rule 531 may be applied to the one or more anomalies to generate a final list or anomalies or to generate one or more alerts. An alert may transmit a message, for instance, send an email, a text message, or a notification. In some implementations, a rule may include threshold, time, and action components. In some implementations, there may be a set of rules 531 that each may generate an alert.

As shown in FIG. 5, memory is shown to optionally include a forecast generator 540. The forecast generator 540 may generate a forecast based on the structural time-series model of the module 520 using one or more parameters specified in the request. The forecast may start from the end of the last time-series data and end after a specified duration. An expected range of value may be generated for each forecast value.

As shown in FIG. 5, memory is shown to include a report generator 550. The report generator 550 may generate a report that includes the time-series data 510, one or more anomalies and/or a forecast. The one or more anomalies may be an aggregate anomaly and/or a slice anomaly. The time-series data 510 may be an aggregate time-series data 511a and/or a slice time-series data 511b. The report generator 550 may also include a “drill-down” suggestion, which is an indication or an annotation on the aggregate time-series data that a slice anomaly has been detected. The “drill-down” suggestion may include information about the slice anomaly and/or the slice time-series data from which the slice anomaly was detected. In some implementations, the report generator 550 may combine the reports from aggregate anomaly, slice anomaly, aggregate time-series data, and/or slice time-series data.

FIG. 6 is an illustration of the Bayesian structural time-series (BSTS) model 600 used to determine anomalies and generate forecasting from time-series data. The BSTS model provides distinction between observed data and latent states. The BSTS model is a type of a state-space approach that allows description of the dynamics of the time-series independently from its observation noise. The BSTS model also provides a hierarchical, fully generative model with priors over all parameters, allowing prior knowledge about the time series to be incorporated. Overfitting may be regularized and prevented, and Bayesian model comparison is enabled. The BSTS model further provides Gaussian random walk over latent states, which corresponds to a maximum-entropy assumption. The BSTS model also allows seasonal components and holiday regressors, allowing the model to judge anomalies after discounting recurring patterns. The BSTS model allows customized events. The BSTS model further aggregates regressors for slice models, avoiding double-flagging anomalies that co-occur in all slices of a data cube by including the aggregate series as a regressor in the model for the individual slices. The BSTS model allows probabilistic annotations, where all annotations represent posterior inferences and therefore have an intuitive probabilistic interpretation. BSTS model also allows meaningful anomaly thresholding, where anomaly threshold is defined in terms of a tail-area probability and thus no hand-tuned thresholds are necessary. In some implementations, the BSTS uses Markov Chain Monte Carlo (MCMC) and Metropolis-Hasting acceptance test, as described in U.S. application Ser. No. 14/030,908 filed Sep. 13, 2013, which is hereby incorporated by reference in its entirety.

The BSTS model 600 holds many advantages over dynamic linear models, which may not provide scalable variable selection and relies on maximum-likelihood estimation that is prone to overfitting and ignoring posterior uncertainty. The BSTS model 600 also has advantages over segmentation and machine-learning techniques which are not generative models that may not provide meaningful uncertainty intervals as well as forecasting.

The model 600 may comprise inputs, a hidden structure, and a plurality of probability distributions. The model 600 may take as input time-series data 615 and plurality of seasonal covariates 614. Each input may be referred to as a component of the model 600. The hidden structure may comprise a plurality of components, including diffusion variance 605, covariates selection 606, regression coefficients 607, observation noise 609, plurality of local trends 610, and plurality of local levels 612. Each component of the model 600 may be referred to as a parameter and/or a latent state of the model 600. MCMC iterations may be used with the model to estimate the values of the components of the hidden structure. In some implementations, each component of the model 600 may comprise or correspond to a respective probability distribution. In some implementations, each time-series data point may correspond to a respective probability distribution. The prior probability distribution, before any MCMC iterations, the uncertainty associated with each component may be high. The uncertainty may be measured by the diffusion or width of each probability distribution. As MCMC iterations are performed, the uncertainty associated with each component will decrease.

The time-series data 615 may be either an aggregate time-series data and/or a slice time-series data. The time-series data 615 may comprise a plurality of data points 615a. Each data point 615a may correspond to a local level 612a and a local trend 610a. Each data point of the time-series data 615a may be modeled 616 as a Gaussian distribution, with a mean of a corresponding local level 612a plus a respective seasonal covariates 614a times a respective regression coefficients 607a, with a respective variance of observation noise 609a. In some implementations, every data point of the time-series data 615 may use a same component for observation noise 609a. In other implementations, each data point of the time-series data 615 may use a unique or a corresponding component as observation noise 609a. Likewise, in some implementations, every data point in the time-series data 615 may use a same component for regression coefficients 607a. In other implementations, each data point of the time-series data 615 may use a unique or a corresponding component as regression coefficients 607a. A hidden structure comprising a greater number of components may result in a more robust model but the model may converge slower and require more iterations. In some implementations, the observation noise 609a may initially be fitted with a spike-and-slab prior, a gamma distribution or any probability distribution with bounded support.

Each local level 612 corresponding to a data point may be modeled 613 as a Gaussian distribution, with a mean of the previous local level plus the previous local trend 610, with a variance of diffusion variance 605a. In some implementations, every local level 612 may use a same component for diffusion variance 605a. In other implementations, each local level 612 may use a unique or a corresponding component as diffusion variance 605a. In some implementations, the first local level 612b may be associated with a diffuse prior which may initially be determined based on the time-series data 615. In some implementations, the first local level 612b may initially be fitted with a spike-and-slab prior. The diffusion variance 605a may also initially be associated with a diffuse prior, such as a gamma distribution, and initially be fitted with a spike-and-slab prior.

Each local trend 610a corresponding to a data point may be modeled 611 as a Gaussian distribution, with a mean of the previous local trend and a variance of a diffusion variance 605b. In some implementations, every local trend 611 may use a same component for diffusion variance 605b. In other implementations, each local trend 611 may use a unique or a corresponding component as diffusion variance 605b. In some implementations, the first local trend 611b may be associated with a diffuse prior which may initially be determined based on the time-series data 615. In some implementations, the first local trend 611a may initially be fitted with a spike-and-slab prior. The diffusion variance 605b may also be initially associated with a diffuse prior, such as a gamma distribution, and initially be fitted with a spike-and-slab prior.

Regression coefficients 607, used in the time-series data model 616, may be a vector of coefficients that measures the effect that an event in the seasonal covariates 614 has on the time-series data 615. In some implementations, the time-series data 615 uses one set of regression coefficients 607a. In other implementations, each data point of the time-series data 615 may have a unique or a corresponding set of regression coefficients 607. Each regression coefficient in a set of regression coefficients 607a may be associated with a Gaussian distribution, with a mean and a variance 605c. In some implementations, the initial values of the mean of the regression coefficients 607 may be set to zero to indicate the prior assumptions that no events in the seasonal covariates 614 correlate with the time-series data 615. In some implementations, the initial values of the variance 605c of the regression coefficients 607 may be set to a spike-and-slab prior, such as a gamma distribution, using a constrained variance matrix. In other implementations, covariance may be calculated to determine each variance of the Gaussian distribution of each regression coefficient. In some implementations, the covariance matrix may be calculated from the time-series data 615. In some implementations, the variance 605c may be the same for each component of the regression coefficients 607 vector, while in other implementations, the variance 605c may be different for each component of the regression coefficients 607 vector.

The covariates selection 606a may select corresponding components of the regression coefficients 607 vector. The selected coefficient may be used as a model 616 for the time-series data 615. The covariance selection 606a may be a vector and each component of the vector may be a value between 0 and 1. A component that has a value closer to 0 would mean that a corresponding component of the regression coefficients 607 vector likely does not affect the time-series data 615. A component that has a value closer to 1 would mean that a corresponding component of the regression coefficients 607 vector likely does affect the time-series data 615. The components of the covariates selection 606a may initially have a diffuse prior, such as a spike-and-slab prior or a gamma distribution.

Forecast values may be added to the model by extending the model to include additional components for local trend 610, local level 612, seasonal covariates 614, and estimates of time-series data 615. For instance, if there are 100 data points available in the time-series data 615 there may be 101 local level 612 components in the hidden structure, where each of the local level 612a corresponds to a data point 615a except the first local level 612b. There may also be 101 local trend components, where each of the local trends are used to compute the next local level 612. The model may also access 100 seasonal covariates 614, each corresponding to the date of the corresponding data point in the time-series data 615. The model may generate forecasting values by extending the hidden structure. For instance, if 10 additional data points are to be generated, then 10 additional local trend 610 components, local level 612 components, and 10 time-series data 615 components may be added, as well as accessing 10 additional seasonal covariates 614 from the global calendar. The additional components are added at the end of the time series data 615, with a duration of 10 times the time resolution. MCMC iterations may be performed with the extended hidden structure, generating forecast values from the 10 additional time-series data 615 components.

After initial values of each of the components of the hidden structure are set, MCMC iterations may be performed to change the values. There are no lower or upper limits to the number of times a MCMC iteration may be performed. The model converges to a posterior distribution as MCMC iterations are performed. The uncertainty values associated with each component of the hidden structure will decrease as iterations are performed as well. Hence, performing more iterations would result in a more accurate result but also requires more time. In some implementations, the MCMC iterations may be performed between hundred times to tens of thousands of times. In some implementations, the MCMC iterations may be performed until one or more uncertainty values of one or more components of the model are under a predefined threshold. In some implementations, the MCMC iterations may be performed until a predefined time budget has been exceeded or met. The time budget may be specified in seconds, minutes, or any other time unit. In some implementations, the MCMC iterations may be performed until reaching a predefined maximum iterations.

FIG. 7A is an illustration 700 of the time-series data. The time-series data may be an aggregate time-series data, a multi-dimensional data, a data cube, or a trend data. The time-series data may be displayed on a graph with one 701 representing the time. The scale and the interval may be determined from the time-series data. The other axis may be determined by the values 715 of the time-series data. An analyst may wish to analyze the data. For instance, the analyst may want to know whether a spike in the data 710 is abnormal. The analyst may also want to know whether there are any other abnormalities in the data.

FIG. 7B is an illustration of a time-series data with expected range of values with detected anomalies and forecasting. Because the model allows forecasting, the time axis 751 may extend to beyond the time for which data is available, such as beyond today 752. At each time, the data values 755 may be compared against the highs 756a and lows 756b that define a range of expected values, also referred to as posterior predictive expectation. The spike 760 in the data is shown to be within the respective range of expected values. The time-series data may also be annotated with found anomalies 761 where the data value lies outside the respective range of expected values. The time-series data may also be annotated with “drill-down” suggestions 762, where anomalies were found at some slice of the data. Forecast values 763, with corresponding expected range of values, may also be displayed. The forecast values 763 is generated from the model and thus anticipates the day-of-week and upcoming holiday effects.

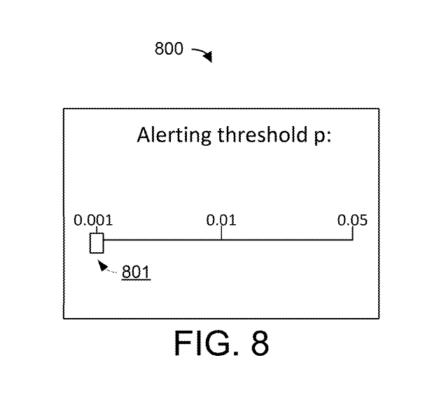

FIG. 8 is an illustration of a graphical interface 800 for specifying a threshold. In some implementations, a slider 801 may be used to set a threshold value for determining an anomaly. In other implementations, a text field may be used. In some implementations, any value of threshold may be used. For instance, the threshold may be set to a value between 0 to 1, or 0% to 100%. An analyst may set a threshold value for which to generate an alert or to detect an anomaly. The threshold may be defined as a tail-end probability or a standard deviation multiplier. In some implementations, only one end (greater than the mean or lesser than the mean) may be specified. In some implementations, an analyst may have the option to set different parameters of the BSTS model, such as the number of iterations, degree of certainty, time budget, dynamic or static variances, etc. In some implementations, an analyst may have the option to set more than one alerts or rules and different components of the rule, such as threshold, time, and action components.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for instance, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for instance, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a web browser through which a user may interact with an implementation of the subject matter described in this disclosure, or any combination of one or more such back-end, middleware, or front-end components. The components of the system may be interconnected by any form or medium of digital data communication (e.g., a communication network). Communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

Thus, particular implementations of the subject matter have been described. Other implementations are within the scope of the following claims. In some cases, the actions recited in the claims can be performed in a different order and still achieve desirable results. In addition, the methods depicted in the accompanying figures do not necessarily require the particular order shown, or sequential order, to achieve desirable results. In certain implementations, multitasking and parallel processing may be advantageous.

What is claimed is:

1. A computer-implemented method for anomaly detection and forecasting time-series data, the method comprising:
receiving, at a server, a request from a client to analyze a time-series data comprising a plurality of data points;
accessing a database of global calendars;
building a structural time-series model from the time-series data and the database of global calendars, the structural time-series model comprising a hidden structure and a plurality of probability distributions, each probability distribution corresponding to a data point;
determining, for each data point of the time-series data, a range of expected values from a respective probability distribution, the range of expected values capturing a predefined percentage of the respective probability distribution;
detecting an anomaly at a first data point of the time-series data responsive to comparing the first data point with a respective range of expected values; and
transmitting the anomaly to the client for display with the time-series data.

2. The method of claim 1, wherein the range of expected values is defined by:
a probability distribution corresponding to the respective data point; and
a percentage value or a standard deviation multiplier.

3. The method of claim 1, wherein the hidden structure comprises a plurality of local levels, a plurality of local trends, a plurality of seasonal covariates, observation noise, a regression coefficients vector, a covariates selection vector, and diffusion variances.

4. The method of claim 1, further comprising:
generating forecast values from the structural time-series model by extending the hidden structure; and
transmitting the forecast values for display with the time-series data.

5. The method of claim 1, further comprising:
generating a slice data from the time-series data, the slice data comprising a portion of the plurality of data points;
building a second structural time-series model from the slice data and the database of global calendars, the second structural time-series model comprising a second hidden structure and a second plurality of probability distributions, each second probability distribution corresponding to a slice data point;
determining, for each slice data point, a range of expected values from a respective second probability distributions, the range of expected values capturing a predefined percentage of the respective second probability distribution;
detecting a slice anomaly at a slice data point of the slice data responsive to comparing the slice data point with a respective range of expected values; and
transmitting the slice anomaly for display with the time-series data.

6. The method of claim 5, further comprising assigning the slice data for analysis to an additional analysis server.

7. The method of claim 5, further comprising:
comparing the slice anomaly with the anomaly; and
detecting the slice anomaly in response to the comparison of the slice anomaly with the anomaly.

8. The method of claim 7, wherein comparing the slice anomaly comprises:
comparing a time of the slice anomaly with a time of the anomaly; and
determining a similarity of the slice anomaly with the anomaly.

9. The method of claim 1, wherein detecting an anomaly comprises
detecting an anomaly at a first data point of the time-series responsive to comparing the first data point with a respective range of expected values and using a rule comprising a threshold.

10. The method of claim 9, wherein the rule further comprises one of time and action components.

11. A computer-implemented system for anomaly detection and forecasting time-series data, the system comprising:
a network interface of a server receiving a request from a client to analyze a time-series data comprising a plurality of data points;
a structural time-series module of the server:
accessing a database of global calendars;
building a structural time-series model from the time-series data and the database of global calendars, the structural time-series model comprising a hidden structure and a plurality of probability distributions, each probability distribution corresponding to a data point;
an anomaly detector of the server:
determining, for each data point of the time-series data, a range of expected values from a respective probability distribution, the range of expected values capturing a predefined percentage of the respective probability distribution;
detecting an anomaly at a first data point of the time-series data responsive to comparing the first data point with a respective range of expected values; and
a report generator of the server,
transmitting the anomaly to the client for display with the time-series data.

12. The system of claim 11, wherein the anomaly detector defines a range of expected values by:
a probability distribution corresponding to the respective data point; and
a percentage value or a standard deviation multiplier.

13. The system of claim 11, wherein the hidden structure comprises a plurality of local levels, a plurality of local trends, a plurality of seasonal covariates, observation noise, a regression coefficients vector, a covariates selection vector, and diffusion variances.

14. The system of claim 11, wherein the structural time-series module further comprises:
generating forecast values from the structural time-series model by extending the hidden structure; and
wherein the report generator further comprises
transmitting the forecast values for display with the time-series data.

15. The system of claim 11, further comprising:
a parallelization module of the server,
generating a slice data from the time-series data, the slice data comprising a portion of the plurality of data points;
a structural time-series module of an additional server,
building a second structural time-series model from the slice data and the database of global calendars, the second structural time-series model comprising a second hidden structure and a second plurality of probability distributions, each second probability distribution corresponding to a slice data point;
an anomaly detector of the additional server:
determining, for each slice data point, a range of expected values from a respective second probability distributions, the range of expected values capturing a predefined percentage of the respective second probability distribution;
detecting a slice anomaly at a slice data point of the slice data responsive to comparing the slice data point with a respective range of expected values; and
the report generator of the server
transmitting the slice anomaly for display with the time-series data.

16. The system of claim 15, further comprising the parallelization module assigning the slice data for analysis to an additional analysis server.

17. The system of claim 15, further comprising the anomaly detector of the additional server:
comparing the slice anomaly with the anomaly; and
detecting the slice anomaly in response to the comparison of the slice anomaly with the anomaly.

18. The system of claim 17, wherein the anomaly detector of the additional server further comprises:
comparing a time of the slice anomaly with a time of the anomaly; and
determining a similarity of the slice anomaly with the anomaly.

19. The system of claim 11, wherein the anomaly detector of the server detecting an anomaly comprises
detecting an anomaly at a first data point of the time-series responsive to comparing the first data point with a respective range of expected values and using a rule comprising a threshold.

20. The system of claim 19, wherein the rule further comprises one of time and action components.
